(19) United States
(12) Patent Application Publication
(10) Pub. No.: US 2022/0105845 A1
(43) Pub. Date: Apr. 7, 2022

(54) AUTOMOBILE

(71) Applicants: TOYOTA JIDOSHA KABUSHIKI KAISHA, Toyota-shi (JP); SUBARU CORPORATION, Tokyo (JP)

(72) Inventors: Junya OKAMURA, Shibuya-ku (JP); Ryo KIMURA, Shibuya-ku (JP); Ryotaro TAKAMI, Toyota-shi (JP)

(73) Assignees: TOYOTA JIDOSHA KABUSHIKI KAISHA, Toyota-shi (JP); SUBARU CORPORATION, Tokyo (JP)

(21) Appl. No.: 17/393,489

(22) Filed: Aug. 4, 2021

(30) Foreign Application Priority Data
Oct. 2, 2020 (JP) 2020-168001

(51) Int. Cl. B60N 2/90; B60N 2/68; B62D 25/20; B62D 25/24

(52) U.S. Cl. CPC B60N 2/90; B62D 25/24; B62D 25/2027; B60N 2/68

(57) ABSTRACT

An automobile includes a base that supports a seat cushion, and electric equipment disposed below the base. The base is provided with a top panel that covers above the electric equipment.

### CROSS-REFERENCE TO RELATED APPLICATION

This application claims priority to Japanese Patent Application No. 2020-168001 filed on Oct. 2, 2020, incorporated herein by reference in its entirety.

### BACKGROUND

### 1. Technical Field

The present disclosure relates to an automobile.

### 2. Description of Related Art

In an automobile disclosed in Japanese Unexamined Patent Application Publication No. 2010-202128 (JP 2010-202128 A), a cushion of a rear seat (seat cushion) is supported by a pipe frame. Using the pipe frame to support the seat cushion realizes reduced weight of the automobile.

### SUMMARY

Automobiles of recent years are provided with a great amount of electric equipment. Electric equipment may be disposed in space below seat cushions as well. When a structure is arranged to support the seat cushion with a pipe frame, liquid spilled by an occupant may seep into the seat cushion, and drip onto the electric equipment below. The present specification provides an automobile having a stricture that protects electric equipment disposed below the seat cushion from wetness.

An automobile according to an aspect of the present disclosure includes: a base that supports a seat cushion; and electric equipment disposed below the seat cushion. The base is provided with a top panel that covers above the electric equipment. According to this aspect, the top panel protects the electric equipment from liquid (wetness) spilled by an occupant.

The technology disclosed in the present specification can be applied to both front seats and rear seats of the automobile. When there are three rows of seats, this can be applied to mid-row seats as well.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of around a rear seat in a vehicle body of an automobile;

FIG. 2 is a planar view around the rear seat in the vehicle body; and

FIG. 3 is a cross-sectional view of the vehicle body cut along line III-III in FIG. 2.

### DETAILED DESCRIPTION OF EMBODIMENTS

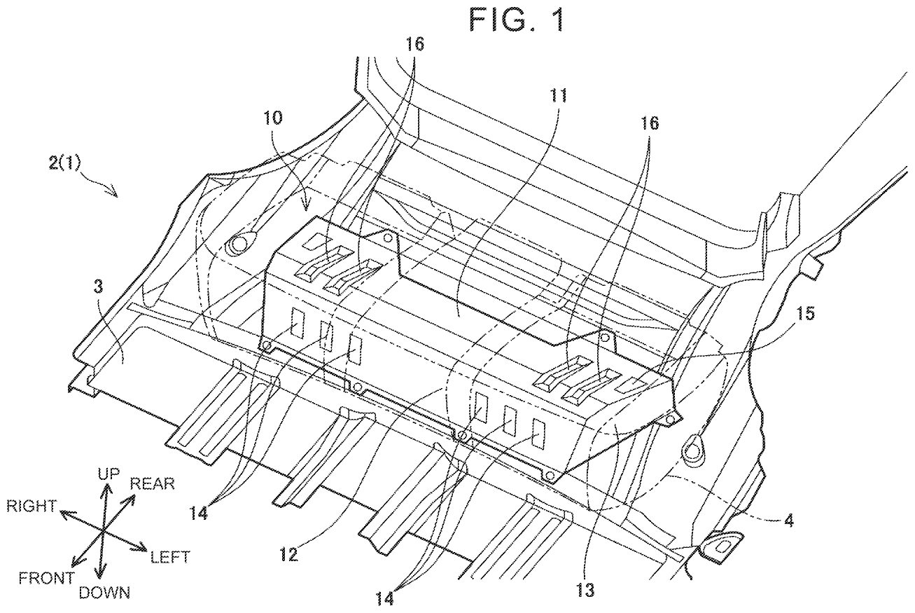

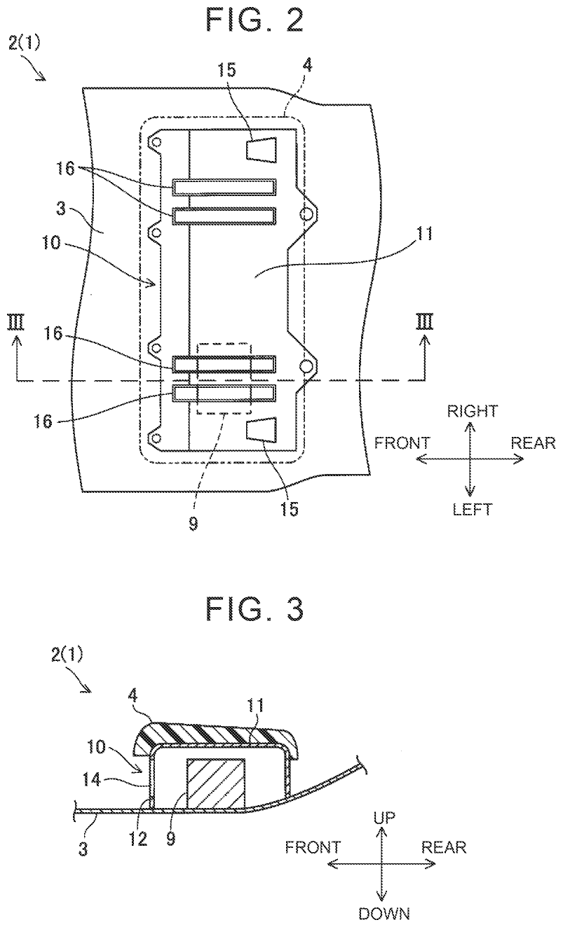

An automobile 1 according to an embodiment will be described with reference to the drawings. FIG. 1 is a perspective view around a rear seat in a vehicle body 2 of the automobile 1. Note that “Front” in the coordinates system in FIG. 1 means the front of the automobile 1. “Left” means the “left” when viewing forward from rearward of the automobile 1. “Rear”, “Up”, “Down”, and “Right” also have similar meanings. In FIG. 1, a cushion of a rear seat (seat cushion 4) is indicated by imaginary lines, with a base 10 that supports the seat cushion 4 visible. In the following, the seat cushion 4 will be referred to as “cushion 4” to simplify description. A back portion of the seat is omitted from illustration in FIG. 1 (and in FIGS. 2 and 3).

The base 10 is a part that supports the cushion 4 as to a floor panel 3. The base 10 is made by stamping from a metal sheet. The base 10 has a top panel 11 situated directly below the cushion 4, and a front panel 12 and side panels 13 that support the top panel 11 as to the floor panel 3. The front panel 12 extends downward from a front edge of the top panel 11. The side panels 13 extend downward from side edges of the top panel 11. The lower ends of the front panel 12 and the side panels 13 are fixed to the floor panel 3. Beads 16 are provided to the top panel 11 to increase flexural rigidity, but no holes are provided to the top panel 11 in a range above the electric equipment 9.

Ventilation holes 14 are provided to the front panel 12, and ventilation holes 15 are provided to the top panel 11 as well. The ventilation holes 15 are provided in end portions of the top panel 11 in the vehicle width direction. Note that the front panel 12 and the side panels 13 may be collectively referred to as “upright panels”

FIG. 2 is a planar view of around the rear seat in the vehicle body 2. FIG. 2 also shows the cushion 4 of the rear seat by imaginary lines, FIG. 3 is a cross-sectional view of the vehicle body 2 cut along line in FIG. 2.

Electric equipment 9 is disposed below the base 10, i.e., below the top panel 11. Note that the electric equipment is hidden by the base 10 and is not visible in FIG. 1. The electric equipment 9 is, for example, an inverter, battery, or the like. The electric equipment 9 is simplified and represented as a rectangle in FIGS. 2 and 3. No holes are provided in the top panel 11 in the range above the electric equipment 9, as described earlier. Even when liquid spilled by an occupant seated on the rear seat seeps into the cushion 4, the liquid is suppressed from dripping onto the electric equipment 9.

The ventilation holes 14 are provided to the front panel 12 of the base 10. The ventilation holes 14 are situated forward from the electric equipment 9. Air in a vehicle cabin flows into the inside of the base 10 through the ventilation holes 14. The air flowing in through the ventilation holes 14 cools the electric equipment 9. Air flowing in through the ventilation holes 15 of the top panel 11 of the base 10 also contributes to cooling the electric equipment 9.

In the automobile according to the related art, the rear seat is supported by a pipe frame. A pipe frame is lightweight, but there is a possibility that liquid seeping into the cushion 4 of the rear seat may drip into the floor panel. Accordingly, disposing electric equipment below the cushion 4 is not desirable when using a pipe frame. In the automobile 1 according to the embodiment, the cushion 4 of the rear seat is supported by the base 10 formed by stamping a metal sheet. No holes are provided in the top panel 11 of the base 10, in the range above the electric equipment 9 and accordingly liquid is suppressed from dripping onto the electric equipment 9 disposed below the top panel 11.

A plurality of the beads 16 is provided to the base 10. The beads 16 increase the flexural strength of the base 10. Providing the beads 16 yields a lightweight and strong base 10. Beads are also provided to the front panel 12 and the side panels 13 of the base 10, but these are omitted from illustration.

Further, the ventilation holes 14 are provided in an upright panel (front panel 12) of the base 10, and can cool the electric equipment 9 by air in the vehicle cabin. Other ventilation holes may be formed in the other upright panels (side panels 13).

Points to take into consideration regarding the technology described in the embodiment will be mentioned here. An example of the rear seat has been described in the embodiment. However, the technology that the present specification discloses can be applied to front seats and mid-row seats as well.

The cushion 4 may include a frame that keeps the form of the soft cushion. The base 10 may support the frame of the cushion. The base 10 may be subjected to cationic electrodeposition.

It is sufficient for the top panel 11 of the base 10 to have no holes provided therein at least in the range above the electric equipment 9. Holes may be provided at positions away from the electric equipment 9 in top view. The reason is that liquid leaking from holes at positions away from the electric equipment 9 will not reach the electric equipment 9.

An inverter (an inverter for supplying alternating current to electric devices brought onboard) may be employed as the electric equipment 9. In this case, electrical outlets (sockets) for supplying alternating current to electric devices may be provided to the ventilation holes 14 of the front panel 12.

Although embodiments have been described above in detail, these are only exemplifications, and do not limit the Claims. The technology set forth in the Claims includes various modifications and alterations of the specific example exemplified above. Technical elements described in the present specification or the drawings exhibit technical utility, either singularly or through various types of combinations, and do not limit combinations set forth in the Claims at the time of application. Also, the technology exemplified in the present specification or the drawings may achieve a plurality of objects simultaneously, and achieving one of these objects in itself has technical utility.

An automobile according to an aspect of the present disclosure includes: a base that supports a seat cushion; and electric equipment disposed below the seat cushion. The base is provided with a top panel that covers above the electric equipment. According to this aspect, the top panel protects the electric equipment from liquid (wetness) spilled by an occupant.

In the above aspect, the base may be made by stamping a metal sheet. By this configuration, the base can be made lightweight. Also, in the above aspect, the base may be provided with an upright panel that supports the top panel as to a floor panel of a vehicle body and that extends in an up-down direction of an vehicle, and a ventilation hole may be provided in the upright panel. By this configuration, the electric equipment below the base can be cooled by air passing through the ventilation hole. In the above aspect, the upright panel may extend downward from a front edge of the top panel, and the ventilation hole may be provided forward from the electric equipment. By this configuration, the electric equipment below the seat can be cooled with air in the vehicle cabin. Further, in the above aspect, the top panel may have a hole at a position away from the electric equipment by a predetermined distance in top view.

What is claimed is:

1. An automobile, comprising:
a base that supports a cushion of a seat; and
electric equipment disposed below the base, wherein
the base is provided with a top panel that covers above the electric equipment.

2. The automobile according to claim 1, wherein the base is made by stamping a metal sheet.

3. The automobile according to claim 2, wherein
the base is provided with an upright panel that supports the top panel as to a floor panel of a vehicle body, and that extends in an up-down direction of an vehicle, and
a ventilation hole is provided in the upright panel.

4. The automobile according to claim 3, wherein
the upright panel extends downward from a front edge of the top panel, and
the ventilation hole is provided forward from the electric equipment.

5. The automobile according to claim 1, wherein the top panel has a hole at a position away from the electric equipment by a predetermined distance in top view.
